(19) United States
(12) Patent Application Publication
(10) Pub. No.: US 2018/0257043 A1
(43) Pub. Date: Sep. 13, 2018

(54) POLYVINYLIDENE DIFLUORIDE MEMBRANE, MANUFACTURING METHOD THEREOF, AND PURIFYING BRINE METHOD THEREOF

(71) Applicant: INDUSTRIAL TECHNOLOGY RESEARCH INSTITUTE, Hsinchu (TW)

(72) Inventors: Chia-Ling LI, New Taipei City (TW); Li-Te HUANG, Hsinchu City (TW); Kuo-Lun TUNG, Taipei City (TW)

(73) Assignee: INDUSTRIAL TECHNOLOGY RESEARCH INSTITUTE, Hsinchu (TW)

(21) Appl. No.: 15/833,123

(22) Filed: Dec. 6, 2017

Related U.S. Application Data
(60) Provisional application No. 62/469,720, filed on Mar. 10, 2017.

(30) Foreign Application Priority Data
Jul. 24, 2017 (TW) 106124726

(51) Int. Cl. B01D 71/34; C08J 9/28; C08J 9/00; B01D 61/36; B01D 67/00; B01D 69/02

(52) U.S. Cl. CPC B01D 71/34; C08J 9/28; C08J 9/009; C08J 9/0071; C08K 9/00; B01D 67/002; B01D 69/02; C08J 2201/0544; C08J 2205/044; B01D 61/364

(57) ABSTRACT

A polyvinylidene difluoride membrane is provided. The polyvinylidene difluoride membrane including polyvinylidene difluoride having a melt viscosity of 35 to 60 (k poise), and the surface of the polyvinylidene difluoride membrane has a pore size of 0.1 μm to 5 μm. A method of manufacturing a porous polyvinylidene difluoride membrane and a method of purifying brine are also provided. The method of purifying brine includes the above-mentioned polyvinylidene difluoride membrane.

### CROSS REFERENCE TO RELATED APPLICATIONS

This application claims the benefit of U.S. Provisional Application No. 62/469,720 filed on Mar. 10, 2017, and claims priority of Taiwan Patent Application No. 106124726 filed on Jul. 24, 2017, the entirety of which are incorporated by reference herein.

### TECHNICAL FIELD

The technical field relates to a polyvinylidene difluoride membrane, a manufacturing method thereof, and a method of purifying the brine thereof.

### BACKGROUND

The direct contact membrane distillation (DCMD) technology controls temperature gradients of fluids at two sides of a film to form a vapor pressure difference. An aqueous solution containing salt enters a high-temperature side of the membrane. The water is driven by the vapor pressure difference across the membrane to the low-temperature side of the membrane through membrane pores as vapor form, and is then condensed to a liquid. As such, the salt is kept at the high-temperature side of the membrane, thereby separating the water from the salt. In DCMD, the membrane is not used to select a substance by the size of its pores. Membrane is only a interface between two solutions with different temperatures. On the whole, the processes of vaporization, mass transfer, and condensation of membrane distillation are similar to common distillation. Therefore, the membrane material used in DCMD requires high porosity, surface porosity, and hydrophobicity with sufficient mechanical strength. PVDF is a common choice. A conventional porous PVDF membrane may have high porosity but with low surface porosity, or it may have small pores and low surface roughness. There is a positive relationship between the flux and the surface porosity. To be more specific: a lower surface porosity will increase the resistance of membrane distillation; in other words, when the pore is too small or there are too few pores, the resistance of the membrane will increase and affect the water flux. The surface hydrophobicity will affect the stability of the DCMD process. For example, a lower surface hydrophobicity or roughness will reduce the operating life of DCMD.

Accordingly, there is a strong need for a polyvinylidene difluoride membrane having high porosity and hydrophobicity with strong mechanical strength on the surface for application in DCMD.

### SUMMARY

One embodiment of the disclosure provides a polyvinylidene difluoride membrane, including polyvinylidene difluoride with a melt viscosity of 35 to 60 k poise, wherein pores of the surface of the polyvinylidene difluoride membrane have a pore size of 0.1 μm to 5 μm.

One embodiment of the disclosure provides a method of manufacturing a porous polyvinylidene difluoride membrane, which includes dissolving a polyvinylidene difluoride with a melt viscosity of 35 to 60 k poise in triethyl phosphate to form a polyvinylidene difluoride solution; and placing the polyvinylidene difluoride solution in water to form a polyvinylidene difluoride membrane, wherein pores on the surface of the polyvinylidene difluoride membrane have a pore size between 0.1 μm to 5 μm.

One embodiment of the disclosure provides a method of purifying brine, comprising the above-mentioned polyvinylidene difluoride membrane between a brine end and a fresh-water end; and passing the water of the brine end through the polyvinylidene difluoride membrane to reach the fresh-water end.

A detailed description is given in the following embodiments with reference to the accompanying drawings.

### BRIEF DESCRIPTION OF THE DRAWINGS

The disclosure can be more fully understood by reading the subsequent detailed description and examples with references made to the accompanying drawings, wherein:

FIG. 1 shows the relationship between the surface open ratio and the water contact angle of a PVDF membrane in one embodiment of the disclosure and comparative examples.

FIGS. 2A to 2M are SEM photographs of a PVDF membrane in Examples 2 and 3 of the disclosure and comparative examples 1 to 11.

FIG. 3 shows a flux and salt rejection of a PVDF membrane in Examples 2 and 3 of the disclosure.

FIG. 4 shows a direct contact membrane distillation device in one embodiment of the disclosure.

FIGS. 5A to 5C show the flux and weathering resistance of a PVDF membrane in one embodiment of the disclosure.

FIGS. 6A to 6B show the pore size distribution of a PVDF membrane in Examples 2 and 3 of the disclosure.

### DETAILED DESCRIPTION

In the following detailed description, for the purposes of explanation, numerous specific details are set forth in order to provide a thorough understanding of the disclosed embodiments. It will be apparent, however, that one or more embodiments may be practiced without these specific details. In other instances, well-known structures and devices are shown schematically in order to simplify the drawing.

In one embodiment of the disclosure, a polyvinylidene difluoride membrane includes polyvinylidene difluoride having a melt viscosity of 35 to 60 (k poise) by ASTM D3835 at 232° C. The polyvinylidene difluoride may have a melt viscosity of 35 to 60 (k poise), but if the melt viscosity is too low, this results in the surface of the polyvinylidene difluoride membrane not having pores. If the melt viscosity is too high, this results in the polyvinylidene difluoride being difficult to dissolve in triethyl phosphate.

In one embodiment, the surface of the polyvinylidene difluoride membrane may have a pore size of 0.1 μm to 5 μm, or 0.5 μm to 3 μm. If the pore size of the polyvinylidene difluoride membrane is less than 0.1 μm, it will have a poor flux. If the pore size is greater than 5 μm, it will have a lower mechanical strength and exhibit poor DCMD stability.

In one embodiment, the surface of the polyvinylidene difluoride membrane may have a surface roughness of 70 nm to 100 nm. If the surface roughness is less than 70 nm, the polyvinylidene difluoride membrane has poor hydrophobicity and a less stable DCMD process. If the surface roughness is greater than 100 nm, it is difficult to give mechanical strength to the porous material.

In one embodiment, the polyvinylidene difluoride membrane includes an oxidation-modified carbon nanotube. Addition of an oxidation-modified carbon nanotube may increase the overall mechanical strength and lifespan of the polyvinylidene difluoride membrane. In one embodiment of the disclosure, the oxidation-modified carbon nanotube and the polyvinylidene difluoride have a weight ratio of 100:8000 to 100:40000. If the weight ratio of the oxidation-modified carbon nanotube is too low, this results in the mechanical strength of the surface of the polyvinylidene difluoride membrane not increasing. If the weight ratio of the oxidation-modified carbon nanotube is too high, this results in the oxidation-modified carbon nanotube being easy to aggregate, and being hard to disperse in a polyvinylidene difluoride solution.

In one embodiment, the polyvinylidene difluoride membrane has a thickness of 80 μm to 200 μm. If the polyvinylidene difluoride membrane is too thin, the mechanical strength of the polyvinylidene difluoride will be too weak. If the polyvinylidene difluoride membrane is too thick, the flux of the membrane will decline.

In one embodiment, the polyvinylidene difluoride membrane have a water contact angle of 120° to 140°. When the water contact angle is within the above range, there is a high hydrophobicity property that is suitable for the separation process of membrane distillation. If the polyvinylidene difluoride membrane have a water contact angle less than 120°, the operational stability and lifespan of the membrane will decline. If the polyvinylidene difluoride membrane have a water contact angle greater than 140°, it becomes hard to give mechanical strength to the porous material.

In one embodiment, the polyvinylidene difluoride membrane has a tensile strength of 0.6 MPa and 3.5 Mpa. If the polyvinylidene difluoride membrane's tensile strength is less than 0.6 MPa, there will be poor mechanical strength. If the polyvinylidene difluoride membrane has a tensile strength greater than 3.5 Mpa, the surface porosity of the polyvinylidene difluoride membrane will decrease, resulting in a declining flux.

According to another embodiment of the disclosure, a method of manufacturing a porous polyvinylidene difluoride membrane includes dissolving a polyvinylidene difluoride with a melt viscosity of 35 to 60 k poise in triethyl phosphate to form a polyvinylidene difluoride solution; and placing the polyvinylidene difluoride solution in water to form a polyvinylidene difluoride membrane, wherein pores on the surface of the polyvinylidene difluoride membrane have a pore size between 0.1 μm to 5 μm.

In one embodiment, in the method of manufacturing a porous polyvinylidene difluoride membrane prepared by the above method, the polyvinylidene difluoride solution has a polyvinylidene difluoride concentration of 6 wt % to 10 wt %. Compared to the high polyvinylidene difluoride concentration used in conventional methods, the lower polyvinylidene difluoride concentration of the disclosure may improve the pore size and the surface porosity of the forming surface of the polyvinylidene difluoride membrane. If the concentration of the polyvinylidene difluoride is too high, this results in the surface of the polyvinylidene difluoride membrane being dense, and no pores can be formed.

In one embodiment, the above step of membrane forming of the polyvinylidene difluoride solution is performed at a temperature of 30° C. to 80° C. Although the dissolution time of the polyvinylidene difluoride will be longer at lower temperatures, the mechanical strength of the polyvinylidene difluoride membrane can be improved.

In one embodiment, the above step of placing the polyvinylidene difluoride solution in water includes placing the polyvinylidene difluoride solution in an annulus of a spinneret; placing the water in an inner tube of the spinneret; and applying pressure to the polyvinylidene difluoride solution and water to make the polyvinylidene difluoride solution and the water simultaneously spin into water in a collection tank through a spinning die to form a tubular polyvinylidene difluoride membrane.

In one embodiment, the spinning liquid and the water is simultaneously spun by a pump, and is spun from the nozzle into a collection tank containing a non-solvent (e.g. water). The distance between the non-solvent surface and the nozzle is 0 (which means that the air gap was 0). If alcohol, a combination of solvent and water, or at ambient air is in the collection tank, the polyvinylidene difluoride cannot be shaped into a membrane by the phase transfer.

In one embodiment, the above polyvinylidene difluoride membrane suitable for use in the method of purifying brine comprises the above-mentioned polyvinylidene difluoride membrane between a brine end and a fresh-water end, and the water of the brine end passes through the polyvinylidene difluoride membrane to reach the fresh-water end.

Below, exemplary embodiments will be described in detail with reference to the accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

### EXAMPLES

### Preparation Example 1

Polyvinylidene difluoride (PVDF, with a melt viscosity between 35 and 60 k poise) was completely evenly dispersed and stirred with a magnetic stirrer in triethyl phosphate (TEP, Alfa Aesar) at 30° C. to 80° C. to prepare a PVDF solution with a concentration of 6 wt % to 10 wt %. The polymer solution was further stirred at the set temperature over 48 hours to form a dope solution. Subsequently, bubbles in the dope solution were removed by a reduced pressure (e.g. vacuum) or just by being left standing for over 24 hours.

### Preparation Example 2 (Modification of Carbon Nanotubes)

10 g of carbon nanotubes were dispersed in 100 g of 30-50 wt % hydrogen peroxide aqueous solution, and then stirred and reacted at 50-105° C. for 3 to 6 hours to oxidize the surface of the carbon nanotubes. The oxidized carbon nanotubes were filtered, then neutralized by washing with de-ionized water, and then dried up in an oven at 50° C. to 80° C. to obtain oxidation-modified carbon nanotubes.

### Preparation Example 3 (Modification of Carbon Nanotubes)

10 g of carbon nanotubes were dispersed in 100 g of 3-5 M nitric acid, and then stirred and reacted at 50-105° C. for 3 to 6 hours to oxidize the surface of the carbon nanotubes. The oxidized carbon nanotubes were filtered, then neutralized by washing with de-ionized water, and then dried up in an oven at of 50° C. to 80° C. to obtain oxidation-modified carbon nanotubes.

### Preparation Example 4

0 to 1.25 wt % of oxidation-modified carbon nanotubes (on the basis of the PVDF weight) was dispersed in triethyl phosphate (TEP) by supersonic vibration, and the PVDF powder was then added into the dispersion. The dispersion containing the PVDF was heated by a hot plate to a dissolving temperature (30° C. to 80° C.) and stirred with a magnetic stirrer until the PVDF was completely dissolved. Thereafter, the PVDF solution (containing the oxidation-modified carbon nanotubes) was continuously stirred at the set temperature over 48 hours to form a dope solution. Subsequently, bubbles in the dope solution were removed by a reduced pressure (e.g. vacuum) or just by being left standing for over 24 hours.

### Example 1

0.06 g of the oxidation-modified carbon nanotubes in Preparation Example 3 was dispersed in 94 g of TEP by supersonic vibration. 6 g of PVDF (with a melt viscosity between 35 and 60 k poise) was added to the dispersion, heated to 30° C. and stirred with a magnetic stirrer until the PVDF was completely dissolved to form a PVDF solution (6 wt %), such as a homogeneous phase dope solution. The dope solution was slowly cooled down to room temperature (20° C. to 30° C.), and bubbles in the dope solution were removed. An appropriate amount of the dope solution was coated on a glass plate by a casting knife to form a casting film with a thickness of 250 μm to 300 μm. The glass plate and the casting film were directly immersed in water for 24 hours, and then dried in ambient air at room temperature to obtain a PVDF membrane with a porous surface.

### Example 2

8 g PVDF (with a melt viscosity between 35 and 60 k poise) was added into 92 g of TEP, and then stirred with a magnetic stirrer at 60° C. to be completely dissolved to form a PVDF solution (8 wt %), which served as a homogeneous spinning solution. An appropriate amount of the spinning solution was put into an annulus of spinneret, and water was put into an inner tube of spinneret. The inner diameter of the annulus had a diameter of 1.06 mm, and the outer diameter of tube had a diameter of 0.7 mm. The spinning liquid and the water was simultaneously spun by a pump, and spun from the spinneret into a collection tank containing a non-solvent (e.g. water). The distance between the non-solvent surface and the spinneret was 0. The spinning rate of the spinning solution and the water was 2 mL/min. The spun object was left in the collection tank for 24 hours. Finally, the object was dried at room temperature and ambient air to obtain a hollow fiber membrane with a porous surface.

### Example 3

0.08 g of the oxidation-modified carbon nanotubes in Preparation Example 3 was dispersed in 92 g of TEP by supersonic vibration. 8 g of PVDF (with a melt viscosity between 35 and 60 k poise) was added to the dispersion, heated to 60° C. and stirred with a magnetic stirrer until the PVDF was completely dissolved to form a PVDF solution (8 wt %), such as a homogeneous phase spinning solution. The spinning solution was slowly cooled to room temperature. An appropriate amount of the spinning solution was put into an annulus of spinneret, and water was put into an inner tube of spinneret. The inner diameter of the annulus had a diameter of 1.06 mm, and the outer diameter of tube had a diameter of 0.7 mm. The spinning liquid and the water was simultaneously spun by a pump, and spun from the spinneret into a collection tank containing a non-solvent (e.g. water). The distance between the non-solvent surface and the spinneret was 0. The spinning rate of the spinning solution and the water was 2 mL/min. The spun object was left in the collection tank for 24 hours. Finally, the object was dried at room temperature and ambient air to obtain a hollow fiber membrane with a porous surface.

In Examples 2 and 3, the surface roughness of the PVDF membrane was analyzed using an atomic force microscope (Model: DMFS-PKG) with the following setting parameters: tip material was single crystal diamond, tip radius <10 nm, imaging resolution 256×256 pixels, scanning rate 0.7 Hz. The surface roughness of the PVDF membrane in Examples 2 and 3 of the disclosure were 81.6 and 87.7 nm, respectively.

In Examples 2 and 3, the mechanical properties of the PVDF membrane such as the tensile strength, yield strength and Young's modulus were analyzed using a universal testing machine, (Model: Cometech QC-505A2), and the following ASTM D882, which is the standard test method for tensile properties of thin plastic sheeting. The universal testing machine covers the determination of mechanical properties of PVDF membrane such as the tensile strength, yield strength and Young's modulus. Specimen area was 2×10 cm strips die cut from thin membrane, and the specimens were placed in the test machine grips of up and down ends, the specimen extension by grip separation at a speed of 10 cm/min, the required strength measured from the computer. The results are shown in Table 1.

When the hollow fiber membranes were analyed, the grips would be sealed by epoxy, and the hollow fiber membranes were placed in the grips to avoid the hollowness of the hollow fiber membranes being damaged by the grips. The length of the tested hollow fiber membranes was unified to 10 cm. The grips were then opened at a rate of 10 cm/min to automatically read the required force by a computer. The results are shown in Table 1.

TABLE 1

| | Example 1 | Example 2 | Example 3 |
|---|---|---|---|
| tensile strength (MPa) | 3.36 | 0.60 | 1.67 |
| elongation rate (%) | 8.5 | 28.4 | 22.0 |
| water contact angle (°) | 137.0 | 123.7 | 127.2 |

### Comparative Example 1

14 g PVDF (with a melt viscosity between 35 and 60 k poise) was added into 86 g of NMP (N-Methyl-2-pyrrolidone), and then stirred with a magnetic stirrer at 60° C. to be completely dissolved to form a PVDF solution (14 wt %), which served as a homogeneous dope solution. The dope solution was slowly cooled down to room temperature, and bubbles in the dope solution were removed. An appropriate amount of the dope solution was coated on a glass plate by a casting knife to form a casting film with a thickness of 250 μm to 300 μm. The glass plate and the casting film were directly immersed in water for 24 hours, and then dried in ambient air at room temperature to obtain a PVDF membrane.

### Comparative Example 2

11 g PVDF (with a melt viscosity between 23 and 29 k poise) was added into 89 g of TEP (triethyl phosphate, Alfa Aesar), and then stirred with a magnetic stirrer at 60° C. to be completely dissolved to form a PVDF solution (11 wt %), which served as a homogeneous dope solution. The dope solution was slowly cooled down to room temperature, and bubbles in the dope solution were removed. An appropriate amount of the dope solution was coated on a glass plate by a casting knife to form a casting film with a thickness of 250 μm to 300 μm. The glass plate and the casting film were directly immersed in water for 24 hours, and then dried in ambient air at room temperature to obtain a PVDF membrane.

### Comparative Example 3

20 g PVDF (with a melt viscosity between 23 and 29 k poise) was added into 80 g of NMP, and then stirred with a magnetic stirrer at 60° C. to be completely dissolved to form a PVDF solution (20 wt %), which served as a homogeneous dope solution. The dope solution was slowly cooled to room temperature, and bubbles in the dope solution were removed. An appropriate amount of the dope solution was coated on a glass plate by a casting knife to form a casting film with a thickness of 250 μm to 300 μm. The glass plate and the casting film were directly immersed in water for 24 hours, and then dried in ambient air at room temperature to obtain a PVDF membrane.

### Comparative Example 4

8 g PVDF (with a melt viscosity between 35 and 60 k poise) was added into 92 g of TMP (Trimethyl phosphate), and then stirred with a magnetic stirrer at 60° C. to be completely dissolved to form a PVDF solution (8 wt %), which served as a homogeneous dope solution. The dope solution was slowly cooled down to room temperature, and bubbles in the dope solution were removed. An appropriate amount of the dope solution was coated on a glass plate by a casting knife to form a casting film with a thickness of 250 μm to 300 μm. The glass plate and the casting film were directly immersed in water for 24 hours, and then dried in ambient air at room temperature to obtain a PVDF membrane.

### Comparative Example 5

8 g PVDF (with a melt viscosity between 35 and 60 k poise) was added into 18.4 g of TBP (Tributyl phosphate) and 73.6 g of NMP, and then stirred with a magnetic stirrer at 60° C. to be completely dissolved to form a PVDF solution (8 wt %), which served as a homogeneous dope solution. The dope solution was slowly cooled down to room temperature, and bubbles in the dope solution were removed. An appropriate amount of the dope solution was coated on a glass plate by a casting knife to form a casting film with a thickness of 250 μm to 300 μm. The glass plate and the casting film were directly immersed in water for 24 hours, and then dried in ambient air at room temperature to obtain a PVDF membrane.

### Comparative Example 6

8 g PVDF (with a melt viscosity between 35 and 60 k poise) was added into 18.4 g of TIPP (Triisopropyl phosphate) and 73.6 g of NMP, and then stirred with a magnetic stirrer at 60° C. to be completely dissolved to form a PVDF solution (8 wt %), which served as a homogeneous dope solution. The dope solution was slowly cooled down to room temperature, and bubbles in the dope solution were removed. An appropriate amount of the dope solution was coated on a glass plate by a casting knife to form a casting film with a thickness of 250 μm to 300 μm. The glass plate and the casting film were directly immersed in water for 24 hours, and then dried in ambient air at room temperature to obtain a PVDF membrane.

### Comparative Example 7

8 g PVDF (with a melt viscosity between 35 and 60 k poise) was added into 13.5 g of Glycerol and 78.5 g of TEP, and then stirred with a magnetic stirrer at 100° C. to be completely dissolved to form a PVDF solution (8 wt %), which served as a homogeneous dope solution. The dope solution was slowly cooled to room temperature, and bubbles in the dope solution were removed. An appropriate amount of the dope solution was coated on a glass plate by a casting knife to form a casting film with a thickness of 250 μm to 300 μm. The glass plate and the casting film were directly immersed in water for 24 hours, and then dried in ambient air at room temperature to obtain a PVDF membrane.

### Comparative Example 8

8 g PVDF (with a melt viscosity between 35 and 60 k poise) was added into 5 g of PVP (polyvinylpyrrolidone) and 87 g of TEP, and then stirred with a magnetic stirrer at 80° C. to be completely dissolved to form a PVDF solution (8 wt %), which served as a homogeneous dope solution. The dope solution was slowly cooled to room temperature, and bubbles in the dope solution were removed. An appropriate amount of the dope solution was coated on a glass plate by a casting knife to form a casting film with a thickness of 250 μm to 300 μm. The glass plate and the casting film were directly immersed in water for 24 hours, and then dried in ambient air at room temperature to obtain a PVDF membrane.

### Comparative Example 9

8 g PVDF (with a melt viscosity between 35 and 60 k poise) was added into 5 g of Polyethylene glycol (PEG600) and 87 g of TEP, and then stirred with a magnetic stirrer at 80° C. to be completely dissolved to form a PVDF solution (8 wt %), which served as a homogeneous dope solution. The dope solution was slowly cooled to room temperature, and bubbles in the dope solution were removed. An appropriate amount of the dope solution was coated on a glass plate by a casting knife to form a casting film with a thickness of 250 μm to 300 μm. The glass plate and the casting film were directly immersed in water for 24 hours, and then dried in ambient air at room temperature to obtain a PVDF membrane.

### Comparative Example 10

8 g PVDF (with a melt viscosity between 35 and 60 k poise) was added into 92 g of TMP, and then stirred with a magnetic stirrer at 60° C. to be completely dissolved to form a PVDF solution (8 wt %), which served as a homogeneous spinning solution. An appropriate amount of the spinning solution was put into an annulus of spinneret, and water was put into an inner tube of spinneret. The inner diameter of the annulus had a diameter of 1.06 mm, and the outer diameter of tube had a diameter of 0.7 mm. The spinning liquid and the water was simultaneously spun by a pump, and spun from the spinneret into a collection tank containing a non-solvent (e.g. water). The distance between the non-solvent surface and the spinneret was 0. The spinning rate of the spinning solution and the water was 2 mL/min. The spun object was left in the collection tank for 24 hours. Finally, the object was dried at room temperature and ambient air to obtain a hollow fiber membrane with a porous surface.

### Comparative Example 11

8 g PVDF (with a melt viscosity between 23 and 29 k poise) was added into 92 g of TEP, and then stirred with a magnetic stirrer at 60° C. to be completely dissolved to form a PVDF solution (8 wt %), which served as a homogeneous dope solution. The dope solution was slowly cooled to room temperature, and bubbles in the dope solution were removed. An appropriate amount of the dope solution was coated on a glass plate by a casting knife to form a casting film with a thickness of 250 μm to 300 μm. The glass plate and the casting film were directly immersed in water for 24 hours, and then dried in ambient air at room temperature to obtain a PVDF membrane.

TABLE 2

| | | | Surface | Tensile | Water |
|---|---|---|---|---|---|
| | | | porosity | strength | contact |
| | Solvent | Additive | (%) | (MPa) | angle (°) |
| Example 2 | TEP | — | 39.7 | 0.6 | 123.7 |
| Example 3 | TEP | — | 50.1 | 1.67 | 127.2 |
| Comparative | NMP | — | 7.3 | 1.66 | 93.8 |
| Example 1 | | | | | |
| Comparative | TEP | — | 11.5 | 0.25 | 95.5 |
| Example 2 | | | | | |
| Comparative | NMP | — | 0.2 | 1.8 | 69.6 |
| Example 3 | | | | | |
| Comparative | TMP | — | 1.6 | 0.36 | 77.4 |
| Example 4 | | | | | |
| Comparative | TBP + NMP | — | 6.1 | 0.27 | 69.1 |
| Example 5 | | | | | |
| Comparative | TIPP + NMP | — | 24.8 | 1.13 | 89.5 |
| Example 6 | | | | | |
| Comparative | TEP | Glycerol | 24.6 | 0.13 | 96.0 |
| Example 7 | | | | | |
| Comparative | TEP | PVP | 23.2 | mechanical | 100.3 |
| Example 8 | | | | strength weak, | |
| | | | | could not | |
| | | | | measure | |
| Comparative | TEP | PEG | 27.2 | 0.20 | 106.9 |
| Example 9 | | | | | |
| Comparative | TMP | — | 20.4 | 1.28 | 99.6 |
| Example 10 | | | | | |
| Comparative | TEP | — | 6.24 | 0.13 | 106.0 |
| Example 11 | | | | | |

Surface porosity analysis was conducted using a high magnification image of SEM photographs (10000×), and using image J software analysis of the ratio of the surface porosity of the membrane. The ratios of the surface porosity of the membrane are shown in Table 2.

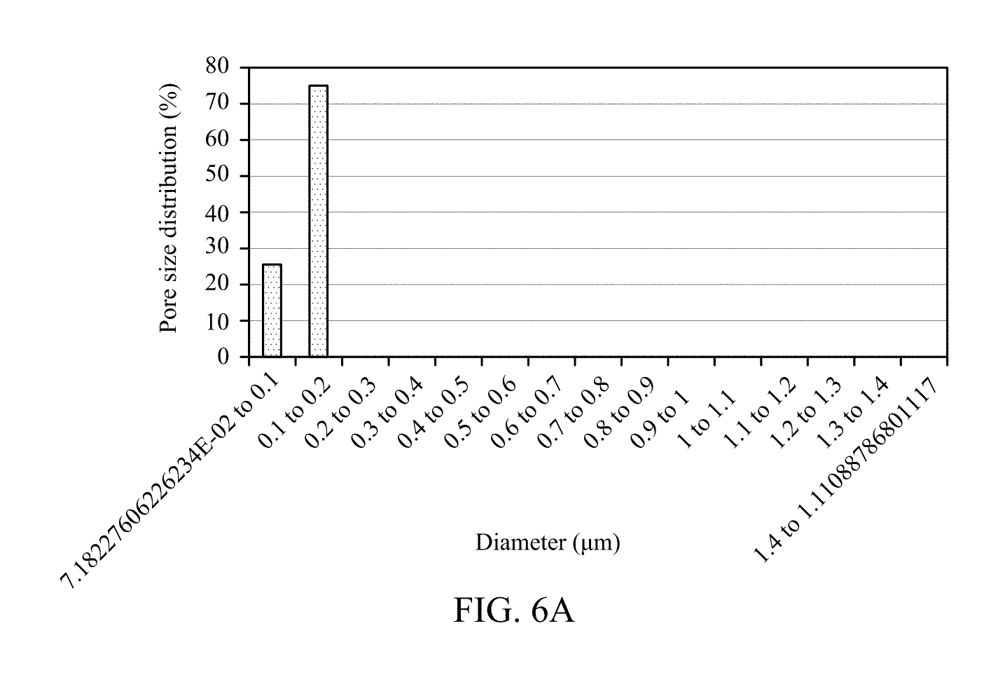

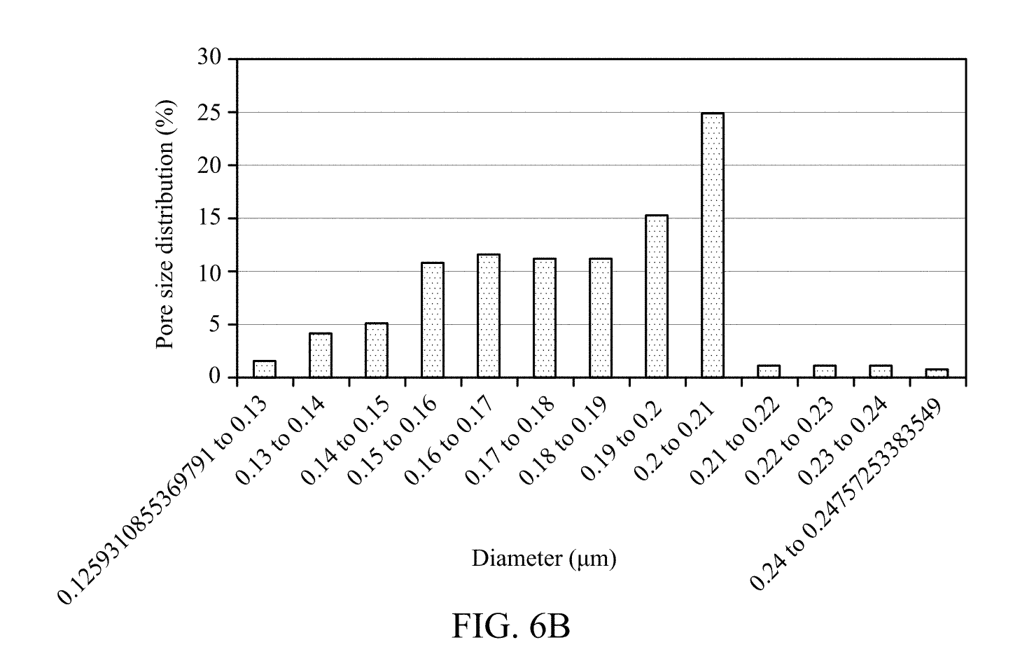

The pore diameter and pore distribution measurement was conducted by Porometer (model, LLP-1200). First, place a fully wetted sample in a sealed chamber, then introduce gas and allow pressure to increase until it is just enough to overcome the fluid's capillary action in the largest pore, increase pressure and measure flow rate as the liquid empties from the pores. Then measure gas pressure and flow rate through the dry sample. Information on various pore parameters can be computed from the pressures and flow rates measured. From the above measurements, it is possible to obtain information on the largest and smallest pores, mean flow pore size, and the distribution of pore sizes in the sample. It can be seen that from FIGS. 6A-6B the pore size distribution of Examples 2 and 3 are mostly at 0.1 μm to 0.2 μm, and about 75%.

Water contact angle measurement using instrument model OPTIMA XE, the water contact angle results are shown in Table 2.

The PVDF membrane analysis of Example 2-3 and Comparative Examples 1 to 11 are shown in Table 2. As shown in Table 2, PVDF melt viscosity, polyvinylidene difluoride concentration and solvent type could affect the surface of the polyvinylidene difluoride membrane pores formed, mechanical strength and hydrophobicity after the formation of the membrane. As shown in Comparative Examples, even if the melt viscosity of the PVDF (35-60 k poise) and the PVDF concentration in the PVDF solution (8 wt %) were same, the PVDF solution with other solvents (not TEP) could not form pores on the surface of the PVDF membrane. Even if the PVDF concentration in the PVDF solution and the TEP was used to dissolve the PVDF, the PVDF with different melt viscosity could not form pores on the surface of the PVDF membrane. If additional pore-creating agent was added into the process, the pore could be formed but the mechanical strength and the hydrophobicity of the membrane would be poor.

SEM photographs in Examples 2A (Example 2), 2B (Example 3), 2C to 2M (Comparative Example 1-1), clearly show that the PVDF melt viscosity and the specific polyvinylidene difluoride concentration can form large pores on the membrane.

### Example 4

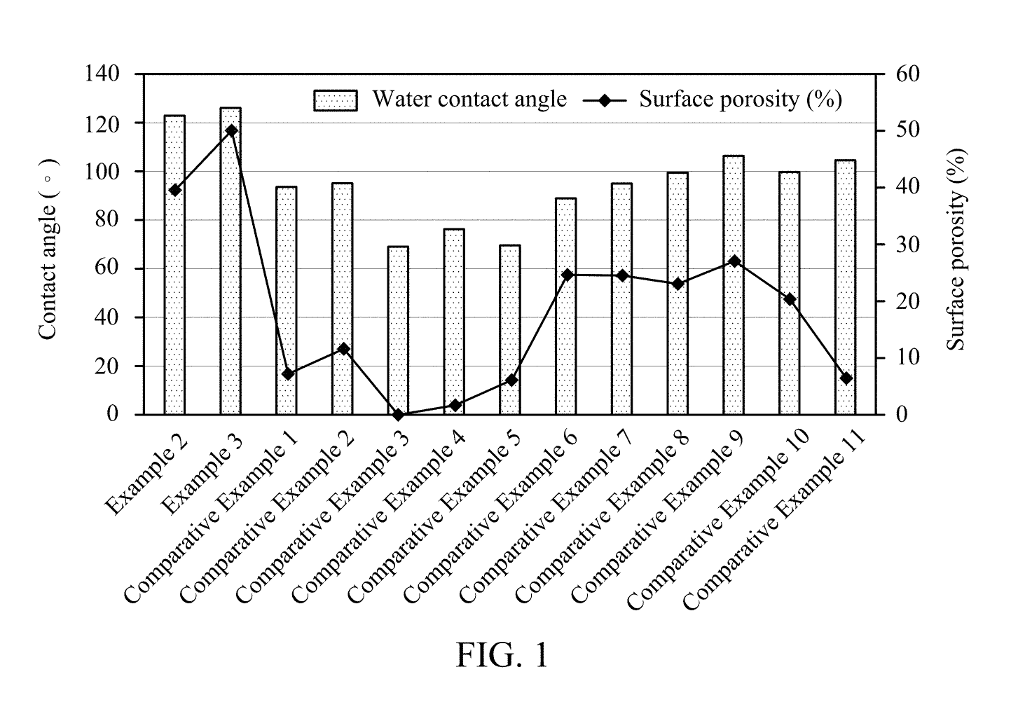

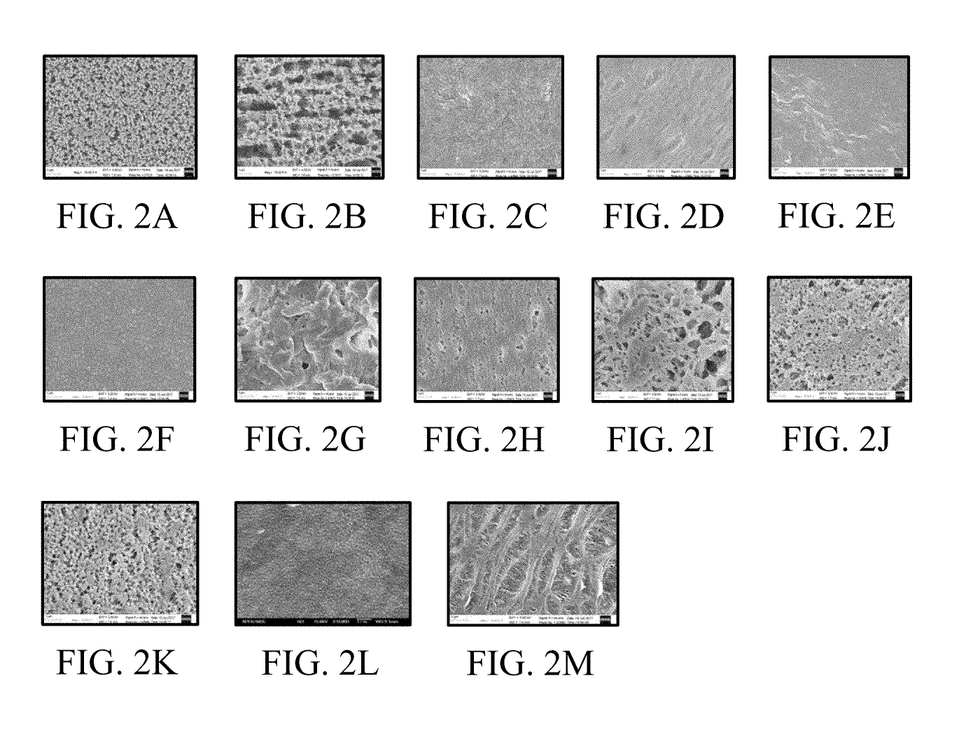

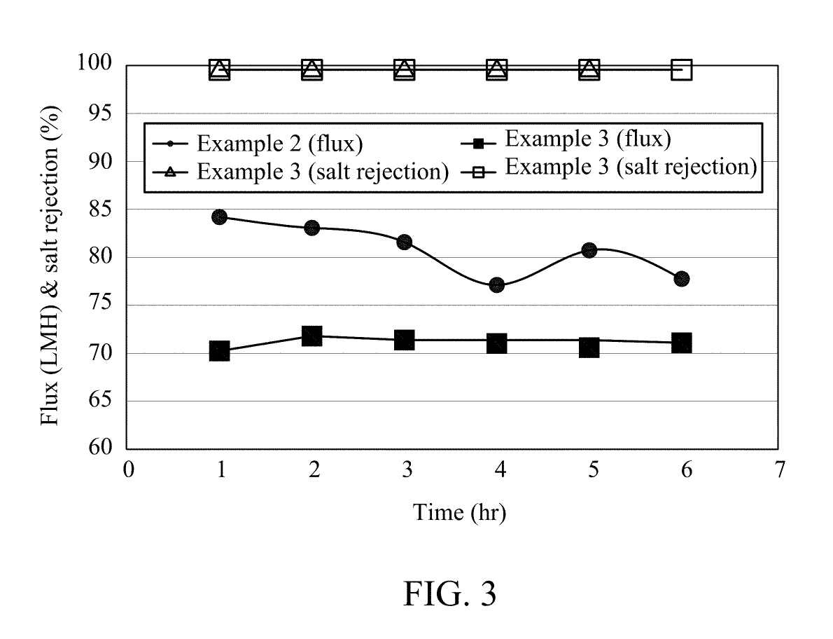

It is clearly illustrated in FIG. 1 that, compared to the prior art, the PVDF membrane of the disclosure does need any additional pore-creating agent to be added, and the pores in the surface of the PVDF membrane (with a surface porosity ratio of about 35-55%) have a surface pore size of about 0.1-3 μm, which shows a high hydrophobicity (water contact angle of 120-130 degrees). If the PVDF membrane contains a pore-creating agent, this will reduce the membrane's hydrophobicity and decrease the stability of the DCMD process. (i.e. it will exhibit a poor DCMD performance).

### Example 5

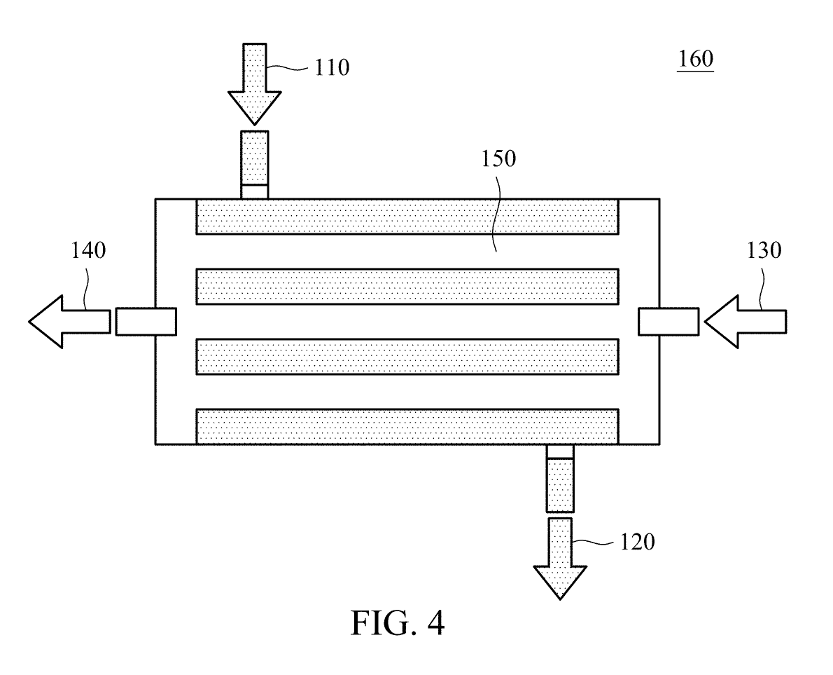

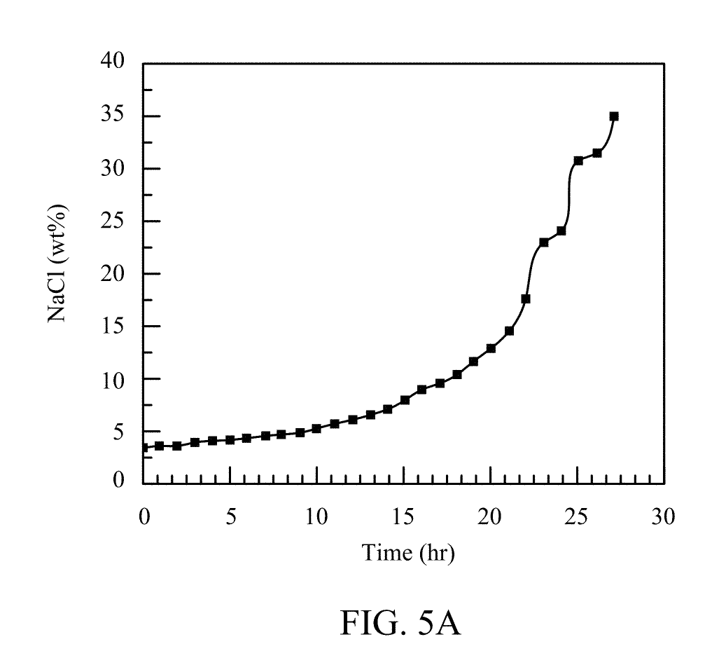

The MD unit was the DCMC type shown in FIG. 4, the membrane thereof was the porous PVDF membrane in Examples 2 and 3, and the inlet end temperature was 72° C. From table 3, the flux of the Examples' PVDF membrane was more than 70 LMH, and the salt rejection rate was 99.9%.

### Example 6

The membrane of the MD water purifying device 160 was the hollow fiber porous PVDF membrane 150 of Examples 2 and 3. The original NaCl aqueous solution before treatment (as shown in FIG. 4) had a temperature of 58-72° C., as the feed solution of the hot water side, and the hot water flow was 1.5 L/min. The feed solution of the hot water side was fed from the inlet end 110 of the device and charged from the other end 120 after the treatment was performed. The pure water had a temperature of 17-20° C., as the feed solution of the cold water side, and the cold water flow was 0.4 L/min. The feed solution of the cold water side was fed from the tube side 130 of the device to be treated and then fed out of the tube side 140 at the other side. Thereby allowing the hot end and the cold end of the aqueous solution to produce a vapor pressure difference, so that the water molecules transit through the vapor phase from the hot salt water end through the PVDF or the PVDF hollow fiber membrane after pure water is collected from the collection end.

### Example 7

TABLE 3

| Example 2 | | B-2007-03 | | B-2008-01 | | B-2009-02 | |
|---|---|---|---|---|---|---|---|
| Feed | Flux | Feed | Flux | Feed | Flux | Feed | Flux |
| temp. (° C.) | (LMH) | temp. (° C.) | (LMH) | temp. (° C.) | (LMH) | temp. (° C.) | (LMH) |
| — | — | — | — | 40.0 | 6.2 | — | — |
| — | — | 50.9 | 14.0 | 49.5 | 11.5 | 50.1 | 11.4 |
| 58.0 | 37.8 | 63.3 | 21.6 | 59.8 | 19.9 | 60.1 | 18.9 |
| 72.2 | 81.6 | 70.5 | 28.1 | 70.2 | 30.8 | 70.0 | 30.4 |
| — | — | 78.2 | 37.4 | 79.3 | 41.5 | 79.5 | 46.1 |
| — | — | 90.3 | 55.2 | — | — | — | — |

| Example 3 | | B-2009-5 | | B-2009-8 | | B-2010-07 | | B-2012-03 | |
|---|---|---|---|---|---|---|---|---|---|
| Feed | Flux | Feed | Flux | Feed | Flux | Feed | Flux | Feed | Flux |
| temp. (° C.) | (LMH) | temp. (° C.) | (LMH) | temp. (° C.) | (LMH) | temp. (° C.) | (LMH) | temp. (° C.) | (LMH) |
| — | — | — | — | 42.2 | 14.8 | — | — | — | — |
| — | — | 50.1 | 14.6 | 55.3 | 31.2 | 50.9 | 24.4 | 50.2 | 26.4 |
| 60.0 | 36.2 | 60.9 | 22.5 | 60.1 | 39.6 | 60.7 | 35.1 | 60.0 | 39.9 |
| 72.0 | 71.0 | 72.2 | 38.6 | 69.8 | 60.2 | 70.6 | 49.2 | 69.9 | 58.4 |
| — | — | 79.9 | 54.3 | 78.4 | 84.1 | 80.4 | 66.9 | 80.1 | 83.4 |
| — | — | 86.0 | 70.1 | — | — | — | — | — | — |

Table 3 shows the PVDF membrane of the literature (B-2007-03, B-2008-01, B-2009-02, B-2009-05, B-2009-08, B-2010-07, B-2012-03, refer to Table 4) in comparison with Examples 2 and 3. From table 3, it is known that the PVDF membrane feed temperatures of Examples 2 and 3 at 72° C. could have more than 70-80 LMH flux of the MD. In view of the fact that the PVDF membrane of the literature achieves the same effect as in the present embodiment, the feed temperature was increased to more than 80° C., which reduces the lifespan of the polyvinylidene difluoride membrane while also increasing unnecessary energy consumption.

TABLE 4

| Number | Literature |
|---|---|
| B-2007-03 | Journal of Membrane Science 306 (2007) 134-146 |
| B-2008-01 | Chemical Engineering Science 63 (2008) 2587-2594 |
| B-2009-02 | Separation and Purification Technology 66 (2009) 229-236 |
| B-2009-05 | AIChE Journal 55 (2009) 828-833 |
| B-2009-08 | Ind. Eng. Chem. Res. 48 (2009) 4474-4483 |
| B-2010-07 | Journal of Membrane Science 364 (2010) 278-289 |
| B-2012-03 | Chemical Engineering Science 68 (2012) 567-578 |

As shown in table 5, adding the oxidized carbon nanotubes to the polyvinylidene difluoride membrane does not affect the flux of the MD.

TABLE 5

| Example 2 | | Example 3 | |
|---|---|---|---|
| Feed | | Feed | |
| temp. | Flux | temp. | Flux |
| (° C.) | (LMH) | (° C.) | (LMH) |
| — | — | — | — |
| — | — | — | — |
| 58.0 | 37.8 | 60.0 | 36.2 |
| 72.2 | 81.6 | 72.0 | 71.0 |
| — | — | — | — |
| — | — | — | — |

### Example 8

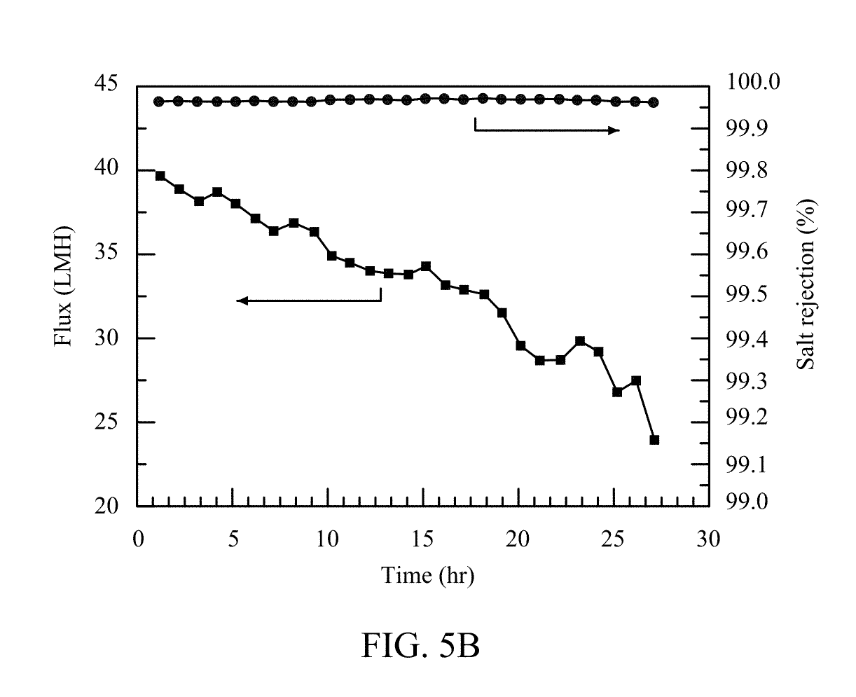

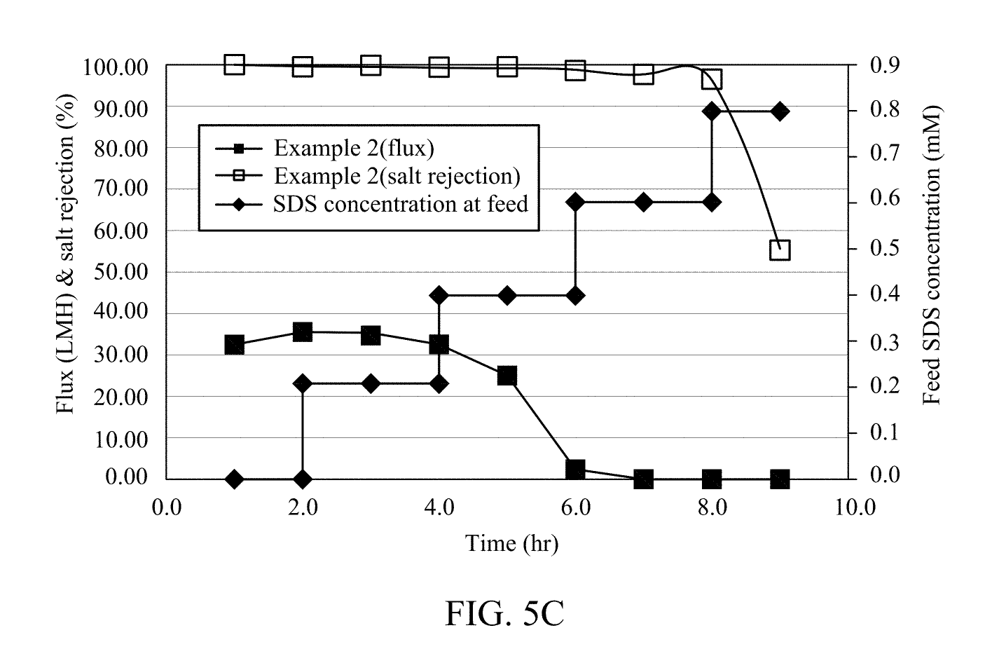

Example of the flux of the MD utilized the porous PVDF membrane in Examples 3. The concentration of NaCl aqueous solution was between 3.5 and 35 wt. % (as shown in FIG. 5A), and the feed temperature was 60° C. It is known from FIG. 5B that even with a concentration of salt up to 35 wt. % and a feed temperature of 58-60° C., the flux of the DCMD can still be maintained between 40-20 LMH, and the salt rejection rate may reach higher than 99.9%. Accordingly, the PVDF membrane of the disclosure could be applied in DCMD even if the brine concentration was high.

### Example 9

Examples of weathering resistance of a PVDF membrane. Wastewater often contains organic pollutants, and it is undesired to swell the membrane of MD. Therefore, weather resistance of the PVDF membrane will affect the filtration efficiency and flux of MD. The membrane thereof was the porous PVDF membrane in Examples 3. The concentration of NaCl aqueous solution was 3.5 wt. % and the feed temperature was 60° C. The timely addition of surfactants (SDS, sodium dodecyl sulfate) included adding 0.2 mM once every 2 hours and observing the change of the flux and salt rejection rate. It is known from FIG. 5C that the flux gradually decreases as the amount of added SDS increases. When the SDS addition amount is 0.4 mM, the membrane flux is reduced to zero (at which point the membrane has lost filtration efficiency). It has been shown that the membrane of the embodiment can withstand a specific concentration of SDS.

In the embodiment of the disclosed polyvinylidene difluoride membrane, the surface pores of the polyvinylidene difluoride membrane can be formed by solvent selection and the combinations of the PVDF melt viscosity and PVDF concentration in the PVDF solution. Reducing the dissolving temperature or adding appropriate oxidation-modified carbon nanotubes can further enhance the mechanical properties and stability of the membrane. Not only do the inner surface and outer surface of the PVDF hollow fiber membrane have a surface porosity, but they also have a high-water flux and a high salt rejection. Without the need for a large amount of solvents for the condensation tank, the process becomes simpler and less expensive.

It will be apparent to those skilled in the art that various modifications and variations can be made to the disclosed methods and materials. It is intended that the specification and examples be considered as exemplary only, with the true scope of the disclosure being indicated by the following claims and their equivalents.

What is claimed is:

1. A polyvinylidene difluoride membrane, comprising: polyvinylidene difluoride with a melt viscosity of 35 to 60 k poise, wherein pores of the surface of the polyvinylidene difluoride membrane have a pore size of 0.1 μm to 5 μm.

2. The polyvinylidene difluoride membrane as claimed in claim 1, wherein the pores of the surface of the polyvinylidene difluoride membrane have a pore size of 0.5 μm to 3 μm.

3. The polyvinylidene difluoride membrane as claimed in claim 1, wherein the pores of the surface of the polyvinylidene difluoride membrane have a surface roughness of 70 nm to 100 nm.

4. The polyvinylidene difluoride membrane as claimed in claim 1, further comprising an oxidation-modified carbon nanotube.

5. The polyvinylidene difluoride membrane as claimed in claim 4, wherein the oxidation-modified carbon nanotube and the polyvinylidene difluoride have a weight ratio of 100:8000 to 100:40000.

6. The polyvinylidene difluoride membrane as claimed in claim 1, having a thickness of 80 μm to 200 μm.

7. The polyvinylidene difluoride membrane as claimed in claim 1, wherein the polyvinylidene difluoride membrane have a water contact angle of 120° to 140°.

8. The polyvinylidene difluoride membrane as claimed in claim 1, wherein the polyvinylidene difluoride membrane has a tensile strength of 0.6 MPa and 3.5 Mpa.

9. A method of manufacturing a porous polyvinylidene difluoride membrane, comprising:
dissolving a polyvinylidene difluoride with a melt viscosity of 35 to 60 k poise in triethyl phosphate to form a polyvinylidene difluoride solution; and
placing the polyvinylidene difluoride solution in water to form a polyvinylidene difluoride membrane, wherein pores of the surface of the polyvinylidene difluoride membrane have a pore size of 0.1 μm to 5 μm.

10. The method as claimed in claim 9, wherein the polyvinylidene difluoride solution has a polyvinylidene difluoride concentration of 6 wt % to 10 wt %.

11. The method as claimed in claim 9, wherein the step of forming the polyvinylidene difluoride solution is performed at a temperature of 30° C. to 80° C.

12. The method as claimed in claim 9, wherein the step of placing the polyvinylidene difluoride solution in water comprises:
placing the polyvinylidene difluoride solution in an annulus of a spinneret;
placing water in an inner tube of the spinneret; and
applying pressure to the annulus and the inner tube to make the polyvinylidene difluoride solution and the water simultaneously spin into water of a collection tank through a spinneret to form a tubular polyvinylidene difluoride membrane.

13. The method as claimed in claim 12, wherein the spinneret directly contacts the water surface in the collection tank.

14. The method as claimed in claim 13, wherein an air gap between the spinneret and the water in the collection tank is zero.

15. A method of purifying brine, comprising:
placing the polyvinylidene difluoride membrane as claimed in claim 1 between a brine end and a fresh-water end; and
passing the water of the brine end through the polyvinylidene difluoride membrane to reach the fresh-water end.
